(19) United States
(12) Patent Application Publication
(10) Pub. No.: US 2009/0057933 A1
(43) Pub. Date: Mar. 5, 2009

(54) Optical Member Fabricating Apparatus and Method and Forming Mold Used for the Same

(76) Inventors: SANG MOOK KIM, Gyeonggi-do (KR); Chul Young Kim, Seoul (KR)

Correspondence Address: Jeff Lloyd;Saliwanchik, Lloyd & Saliwanchik, A Professional Association, PO Box 142950, Gainesville, FL, 32614-2950, US

(21) Appl. No.: 12/202,181

(22) Filed: Aug. 29, 2008

Related U.S. Application Data
(62) Division of application No. 11/378,909, filed on Mar. 17, 2006.

(51) Int. Cl. B29D 11/00

(52) U.S. Cl. 264/1.38; 264/1.7

(57) ABSTRACT

Provided is an apparatus for fabricating an optical member. The apparatus includes a first roll around which a base film is wound, a second roll around which a base film on which a coating liquid is applied in a predetermined pattern is wound, two or more guide rolls disposed between the first and second rolls to convey the base film, an injection unit for injecting the coating liquid, a pattern molding unit engaged with one of the guide rolls to apply the injected coating liquid on the base film in the predetermined pattern, and a hardening unit for hardening the coating liquid applied on the base film.

### CROSS-REFERENCE TO RELATED APPLICATION

This application is a divisional of U.S. application Ser. No. 11/378,909, filed Mar. 17, 2006, which is hereby incorporated herein by reference in its entirety.

### BACKGROUND OF THE INVENTION

1. Field of the Invention

The present invention relates to an optical member fabricating apparatus and method that can mass-produce optical members each having a micro-scale or nano-scale size and used for a display or an optical device and improve a yield in producing the optical members. The present invention further relates to a forming mold used for the optical member fabricating apparatus and method.

2. Description of the Related Art

An optical member has been widely used in a display field as a diffuser film for diffusing light in a liquid crystal display (LCD) or a prism film for collecting diffused light to improve the collimation of the light. In addition, the optical member has been used as a hologram film or a cube corner film.

The early films were independently produced one by one. However, in recent years, as the fine process technology has been developed, the films have been mass-produced through a roll-to-roll method, thereby enhancing the competitiveness in the market.

A prior art fabricating method of mass-producing the optical member is classified into a direct process method in which a pattern master that is mechanically processed is directly used as a forming mold and a stampper process method in which a forming mold is formed of a metal film formed by electro-plating the pattern master.

In the direct process method, a pattern is mechanically formed on the surface of a cylindrical mold and the mold is directly mounted on an optical member fabricating apparatus. A forming material is injected into a space defined between the mold and a base film and hardened. The hardened material is applied and/or fixed to the base film.

In the stampper process method, a stampper is tightly fixed on the surface of a cylindrical metal support and a forming material is injected into a space defined between a mold and a base film of the apparatus, hardened and continuously applied/conveyed to the base film. At this point, in order to harden the applied material, heat is generally applied to the mold to increase the transferring property. Alternatively, a material that is hardened by reacting on an ultraviolet ray may be used.

FIG. 1 is a view of a prior art optical member fabricating apparatus.

Referring to FIG. 1, a prior art optical member fabricating apparatus includes a first roll 20 around which a base film 10 is wound and a second roll 50 around which the base film 10 on which an optical pattern 12 is formed is wound. The first and second rolls 20 and 50 are driven while supporting the base film 10.

Disposed between the first and second rollers 20 and 50 are guide rolls 30a through 30d for conveying the base film 10 and a pattern roll 40 for forming the optical pattern on the base film 10. A coating liquid injection unit 60 for supplying coating liquid 62 used for forming the optical pattern 12 on the base film 10 is placed adjacent a location where the base film 10 enters the pattern roll 40. A hardening unit 70 is disposed around the pattern roll 40 to harden the coating liquid applied on the base film.

While the base film 10 released from the first roll 20 is conveyed along the guide rolls 30a through 30d, it contacts the pattern roll 40. At this point, the coating liquid 62 is injected into an area where the base film 10 contacts the pattern roll 40. The injected coating liquid 62 is applied on the base film 10 in the form of the optical pattern 12 correspond to the pattern of the pattern roll 40. The optical pattern formed on the base film 10 is hardened by the heat or UV light emitted from the hardening unit 70.

Therefore, the optical pattern 12 formed of the coating liquid is formed on the base film 10 as the base film 10 passes through the pattern roll 40.

The guide roll 30b allowing the base film 10 to enter into the pattern roll 40 functions to adjust a thickness of the optical pattern 12 formed on the base film 10. That is, when the guide roll 30b closely contacts the pattern roll 40, the base film closely contacts the pattern roll 40 and thus a thickness of the optical pattern 12 on the base film 10 is reduced. When the guide roll 30b is spaced apart from the pattern roll 40 by a predetermined distance, the gap between the base film 10 and the pattern roll 40 is widened and thus the thickness of the optical pattern on the base film 10 increases.

The base film 10 on which the optical pattern 12 that is formed on the base film 10 is conveyed from the pattern roll 40 by the guide roll 30c and wound around the second roll 50. FIGS. 2a and 2b are sectional views of forming molds that can be used as the pattern roll depicted in FIG. 1. FIG. 2a shows a forming mold used in the direct process method using the pattern master and FIG. 2b shows a forming mold used in the stampper process method.

As shown in FIG. 2a, in the direct process method, the master roll on which a pattern 42 is formed is directly mounted on the apparatus. Then, the forming material is filled in the space defined between the base film and the pattern 42 on the mater roll. The forming material filled in the space is hardened by emitting the heat or ultraviolet ray. Then, the base film is separated from the master roll so that a pattern corresponding to the pattern 42 of the master roll is formed on the base film. At this point, the forming material is selected from materials that can be easily separated from a processed surface of the master roll that is formed of metal.

As shown in FIG. 2b, the stampper process method is basically similar to the direct process method except that a stampper mold 46 fixedly contacting a cylindrical mold support 44 and having the pattern 42 is used instead of the master roll.

Meanwhile, in the case of the direct process method using the master roll, since the pattern process area having a diameter above 500 mm must be processed to improve the productivity, the cost for processing the pattern increases by geometrical progression.

Furthermore, since the weight and volume of the apparatus increase, it is difficult to handle the apparatus. Furthermore, the final products may be partly polluted due to the poor work during the production process. In addition, the master roll may be scratched or worn. In this case, the master roll must be repaired or replaced, thereby increasing the manufacturing cost.

Additionally, it is difficult to mechanically process a fine shape having a micro-scale or nano-scale size. Particularly, since it is actually impossible to mechanically process the intaglio master pattern, the direct process method can be applied only when the intaglio and relief patterns are identical to each other.

In the case of the stampper process method, it is difficult to process the stampper mold. That is, the process for manufacturing the stampper mold is complicated. Therefore, when the stampper mold is large-sized, the time for manufacturing the stampper mold is prolonged and it is difficult to manufacture the stampper mold having a uniform thickness. Furthermore, when the stampper mold is bent or deformed during handling, it is impossible to recover the same.

Therefore, the stampper mold is mainly used for a small, flat type compression forming. That is, the stampper mold is not proper to be used in a relatively large-sized roll-to-roll production.

In addition, since the mold support on which the stampper mold is mounted has a joint 465a between opposite ends thereof, a poor pattern may be generated at the joint portion, thereby deteriorating the yield.

### SUMMARY OF THE INVENTION

Accordingly, the present invention is directed to an optical member fabricating apparatus and method and a forming mold used for the apparatus and method that substantially obviate one or more problems due to limitations and disadvantages of the related art.

An object of the present invention is to provide an optical member fabricating apparatus and method and a forming mold that can continuously mass-produce the fine optical members and improve the yield and handling property, thereby reducing the manufacturing costs.

Another object of the present invention is to provide an optical member fabricating apparatus and method and a forming mold that can realize a variety of patterns having a variety of intaglio and relief without being limited by the shape of the patterns.

A still another object of the present invention is to provide an optical member fabricating apparatus and method and a forming mold that can form a large-sized pattern.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an apparatus for fabricating an optical member, including: a first roll around which a base film is wound; a second roll around which a base film on which a coating liquid is applied in a predetermined pattern is wound; two or more guide rolls disposed between the first and second rolls to convey the base film; an injection unit for injecting the coating liquid; a pattern molding unit engaged with one of the guide rolls to apply the injected coating liquid on the base film in the predetermined pattern; and a hardening unit for hardening the coating liquid applied on the base film.

In another aspect of the present invention, there is provided an apparatus for fabricating an optical member having a first fine pattern and used in an optical device, the fine pattern being formed using a forming mold having a second fine pattern opposing to the first fine pattern, the apparatus including: a first roll around which a base film is wound; a second roll around which the optical member wound; two or more guide rolls disposed between the first and second rolls to convey the base film and the optical member; a pattern molding unit having a master roll engaged with one of the guide rolls and a pattern guide roll for conveying the forming mold; an injection unit for injecting coating liquid between an area where the master roll and the guide roll are engaged with each other; and a hardening unit for hardening the coating liquid applied on the base film.

In still another aspect of the present invention, there is provided a method of fabricating an optical member, including: conveying a base film that is a base material of the optical member; conveying a forming mold having a predetermined pattern; allowing the base film to be engaged with the forming mold; injecting coating liquid in an area where the base film is engaged with the forming mold; hardening the injected coating to fix the coating liquid on the base film; and separating the forming mold from the base film on which the coating liquid is fixed.

In still yet another aspect of the present invention, there is provided a forming mold used for fabricating an optical member, including: a base layer that is a base material of the optical member used in a display or an optical device; a pattern layer formed on a surface of the base layer; and a frictional member formed on an opposite surface of the base layer to increase the frictional force with a roll conveying the optical member.

According to the present invention, the work efficiency and yield can be improved in manufacturing the optical members, thereby reducing the manufacturing costs.

Since the forming mold is formed of a film, the cost for processing the master pattern is reduced.

Since the returning cycle of the joint of the forming mold is prolonged or the join is omitted, the pattern defective is reduced, thereby improving the yield and quality of the optical member.

When there is a predetermined pattern, the reverse shape can be used as the forming mold. Therefore, a fine shape that is difficult to be processed or formed can be easily formed.

A large size fine forming is possible using the roll-to-roll method. Therefore, the intaglio and relief pattern can be easily formed.

By forming the projections or thin film on the bottom surface of the base layer of the forming mold, the friction force between the forming mold and the surface of the master roll increases, thereby preventing the slip of the forming mold on the master roll.

Furthermore, the structure of the pattern molding and the forming mold can be variably modified, it can be widely used to a variety of applications.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view of a prior art optical member fabricating apparatus;

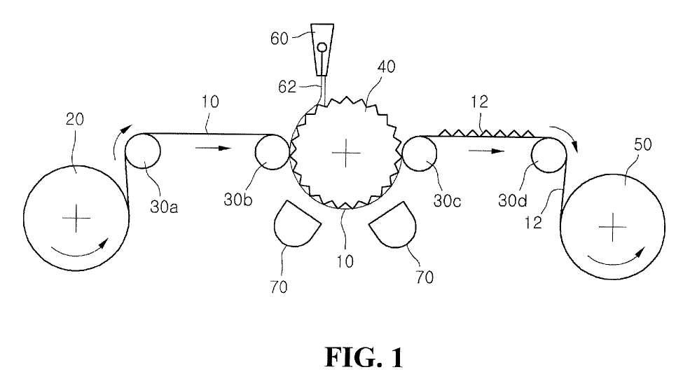

FIGS. 2a and 2b are sectional views of forming molds that can be used as the pattern roll depicted in FIG. 1;

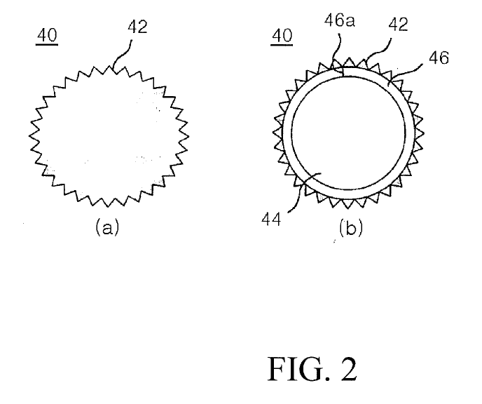

FIG. 3 is a schematic view of an optical member fabricating apparatus according to an embodiment of the present invention;

FIG. 4 is a schematic view of an optical member fabricating apparatus according to a second embodiment of the present invention;

FIG. 5 is a sectional view of a forming mold according to a first embodiment of the present invention;

FIG. 6 is a sectional view of a forming mold according to a second embodiment of the present invention; and

FIG. 7 is a sectional view of a forming mold according to a third embodiment of the present invention.

### DETAILED DESCRIPTION OF THE INVENTION

Reference will now be made in detail to the preferred embodiments of the present invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. Wherever possible, the same reference numbers will be used throughout the drawings to refer to the same or like parts.

In the drawings, the size of each part is exaggerated for clarity.

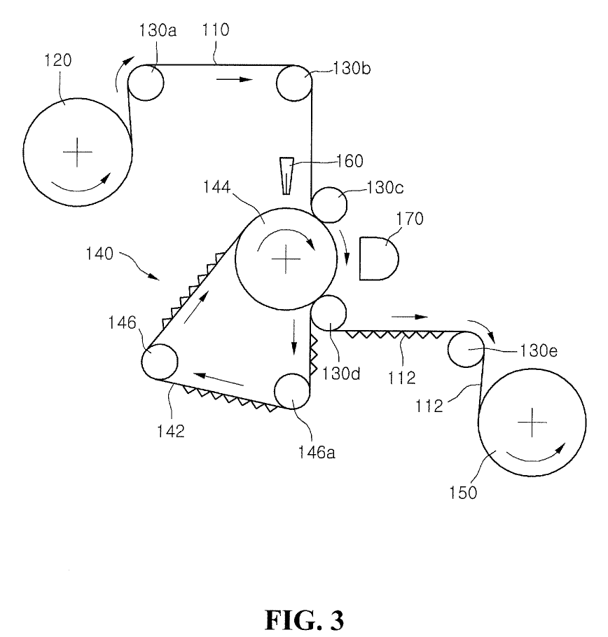

FIG. 3 is a schematic view of an optical member fabricating apparatus according to a first embodiment of the present invention.

Referring to FIG. 3, the optical member fabricating apparatus of this embodiment includes a first roll 120 around which a base film 110 is wound, a second roll 150 on which the base film 110 on which an optical pattern 112 is formed is wound, and first through fifth guide rolls 130a through 130e for conveying the base film 110.

Although five guide rolls 130a through 130e are exampled in this embodiment, the present invention is not limited to this. For example, the number and locations of guide rolls may vary.

The optical member fabricating apparatus of this embodiment further includes a pattern molding unit 140 disposed between the third and fourth guide rolls 130c and 130d to apply coating liquid on the base film 110. The pattern molding unit 140 functions as the pattern roll of the prior art.

That is, the pattern molding unit 140 includes a forming mold 142 having a predetermined pattern, a master roll 144 for applying the injected coating liquid on the forming mold in a predetermined pattern corresponding to that of the forming mold 142 and applying the predetermined pattern of the coating liquid on the base film 110, and first and second pattern guide rolls 146a and 146b for conveying the forming mold 142.

The forming mold 142 is a belt-type mold formed by applying a pattern layer on a base film and functioning as the prior art pattern roll forming the coating liquid in a predetermined pattern.

Although the pattern of the forming mold is partly shown in FIG. 3, the pattern is actually formed on the overall surface of the pattern layer of the forming mold.

The forming mold 142 extends along the extending lines interconnecting the master roll 144 and the guide rolls 146a and 146b and opposite ends of the forming mold 142 are joined together with each other.

At this point, a joint is formed by the joined opposite ends of the forming mold 142. However, since the returning cycle of the joint of the forming mold 142 is greatly longer than that of the prior art pattern roll, the cycle of the generation of the poor pattern is prolonged, thereby improving the yield in fabricating the optical members. In order to further increase the returning cycle of the joint, distances between the master roll 144 and the pattern guide rolls 146a and 146b can increase to increase the length of the forming mold 142.

Furthermore, the optical member fabricating apparatus of this embodiment further includes a coating liquid injection unit 160 for injecting the coating liquid into an area where the base film 110 starts contacting the pattern molding unit 140 and a hardening unit 170 for hardening the injected coating liquid by emitting heat or UV light.

The operation of the optical member fabricating apparatus of this embodiment will now be described.

First, the base film wound around the first roll 120 is conveyed by the first through fifth guide rolls 130a through 130e. At this point, the forming mold 142 of the pattern molding unit 140 rotates by the master roll 144 and the pattern guide rolls 146a and 146b.

Furthermore, since the master roll 144 is engaged with the third and fourth guide rolls 130c and 130d, the base film 110 contacts the forming mold 142 by the third guide roll 130c. Particularly, the third guide roll 130c functions to adjust a gap defining the thickness of the optical pattern 112 that is formed on the base film 110 by applying the coating liquid on the base film 110.

That is, as the third guide roll 130c is closer to the master roll 144, the thickness of the optical pattern 112 of the optical member is reduced. On the contrary, as the third guide roll 130c is far away from the master roll 144, the thickness of the optical pattern 112 of the optical member increases. The thickness of the optical member depends on a viscosity of the coating liquid, a patterning speed, and a tension of the base film, as well as the gap between the third guide roll 130c and the master roll 144.

Meanwhile, the coating liquid is injected through a location where the base film 110 is intruded between third guide roll 130c and the master roll 144 and filled in spaces formed by the pattern formed on the forming mold 142.

The coating liquid filled in the pattern formed on the forming mold 142 is uniformly applied on the base film 110 by a pressure generated between the third guide roll 130c and the master roll 144, thereby forming a predetermined pattern corresponding to the pattern of the forming mold 142 on the base film 110. At this point, the coating liquid filled in spaces formed by the pattern of the forming mold 142 is hardened by the heat or UV light emitted from the hardening unit 170.

The base film 110 on which the coating liquid pattern (the optical pattern 112) is separated from the forming mold 142 by being advanced by the fourth guide roll 130d, conveyed by the fifth guide roll 130e, and wound around the second roll 150.

Here, the fourth guide roll 130d functions to separate the base film 110 on which the optical pattern 112 is formed from the forming mold 142.

The base film 110 on which the optical pattern 112 is formed can be referred as the optical member.

That is, the optical member includes the base film 110 and the optical pattern 112 formed on the base film 110. In FIG. 3, although the optical pattern 112 is not shown on the base film 110 wound around the second roll 150, the optical pattern 112 is actually formed on the base film 110 wound around the second roll 150.

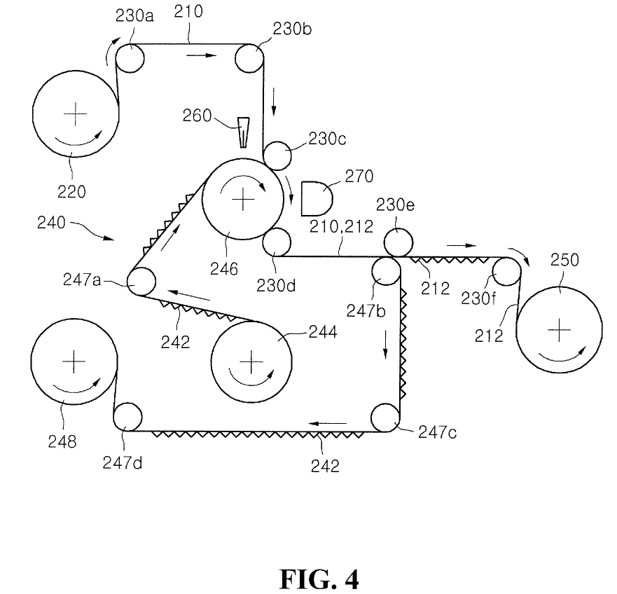

FIG. 4 is a schematic view of an optical member fabricating apparatus according to a second embodiment of the present invention. In this embodiment, the pattern molding unit of FIG. 3 is modified.

Referring to FIG. 4, the optical member fabricating apparatus of this embodiment includes a first roll 220 around which a base film 210 is wound, a second roll 250 on which the base film 210 on which an optical pattern 212 is formed is wound, and first through sixth guide rolls 230a through 230f for conveying the base film 210. Although six guide rolls 230a through 230f are exampled in this embodiment, the present invention is not limited to this case. For example, the number and locations of guide rolls may vary.

The optical member fabricating apparatus of this embodiment further includes a pattern molding unit 240 disposed between the third and fourth guide rolls 230c and 230d to apply coating liquid on the base film 210.

That is, the pattern molding unit 240 includes a forming mold 242 having a predetermined pattern, a third roll 244 around which the forming mold is wound, a master roll 246 for applying the injected coating liquid on the forming mold to form the coating liquid in a predetermined pattern corresponding to that of the forming mold 242 and apply the predetermined pattern of the coating liquid on the base film 210, first and second pattern guide rolls 246a and 246b for conveying the forming mold 242, and a fourth roll 248 around which the conveyed forming mold 242 is wound.

The forming mold 242 is wound around the third roll 244 and conveyed by the master roll 246 and the pattern guide rolls 247a through 247d. After forming a pattern formed of coating liquid on the base film 210, the forming mold 242 is wound around the fourth roll 248.

At this point, the forming mold 210 may have a length same as that of the base film 210. Therefore, the forming mold 210 can form a uniform optical pattern 212 on the base film 210 without a poor pattern or intermittent pattern that may be caused by the joint of the forming mold 210. Although the pattern of the forming mold is partly shown in FIG. 4, the pattern is actually formed on the overall surface of the pattern layer of the forming mold.

Furthermore, the optical member fabricating apparatus of this embodiment further includes a coating liquid injection unit 260 for injecting the coating liquid through a location where the base film 210 enters the pattern molding unit 240 and a hardening unit 270 for hardening the injected coating liquid by emitting heat or UV light.

The operation of the optical member fabricating apparatus according to the current embodiment of the present invention will now be described. First, the base film 220 wound around the first roll 220 is conveyed by the first through third guide rolls 230a through 230c and is introduced into a region where the third guide roll 230c and the master roll 246 are engaged with each other.

At this point, the forming mold 242 of the pattern molding unit 240 is released from the third roll 244, conveyed by the first pattern guide roll 247, and introduced between the master roll 246 and the third guide roll 230c to closely contact the base film 210.

Particularly, the third guide roll 230c functions to adjust a gap defining the thickness of the optical pattern 212 that is formed on the base film 110 by applying the coating liquid on the base film 210.

Meanwhile, the coating liquid is injected through a location where the base film 210 is intruded between third guide roll 230c and the master roll 246 and filled in spaces formed by the pattern formed on the forming mold 242.

The coating liquid filled in the pattern formed on the forming mold 242 is uniformly applied on the base film 210 by a pressure generated between the third guide roll 230c and the master roll 246, thereby forming the optical pattern 212 corresponding to the pattern of the forming mold 242 on the base film 210. At this point, the coating liquid filled in spaces formed by the pattern of the forming mold 242 is hardened by the heat or UV light emitted from the hardening unit 270.

The base film 210 on which the coating liquid pattern (the optical pattern 212) is conveyed by the fourth and fifth guide rolls 230d and 230e and the forming mold is conveyed by the fourth guide roll 230d and the second pattern guide roll 247b.

Therefore, in a section between the fourth and fifth guide rolls 230d and 230e and a section between the fourth guide roll 230d and the second pattern guide roll 247b, the base film 210 on which the optical pattern is formed and the forming mold 242 are conveyed in a state where they closely contact each other.

The base film 210 on which the optical pattern 212 is formed is further conveyed by the sixth guide roll 230f and wound around the second roll 250. At this point, the forming mold 242 is conveyed by the third and fourth pattern guide rolls 247c and 247d and wound around the fourth roll 248. Here, the fifth guide roll 230e and the second pattern guide roll 247b function to separate the base film 210 on which the optical pattern 212 is formed from the forming mold 242.

Meanwhile, when the length of the forming mold 242 is same as that of the base film 210, the optical pattern 212 is continuously formed on the overall surface of the base film 210 until the forming mold 242 is wound around the fourth roll 248 after being released from the third roll 244. Therefore, no poor pattern caused by the joint of the forming mold is formed on the base film 210.
Although the optical pattern 212 is not shown on the base film 210 wound around the second roll 250, the optical pattern 212 is actually formed on the base film 210 wound around the second roll 250.

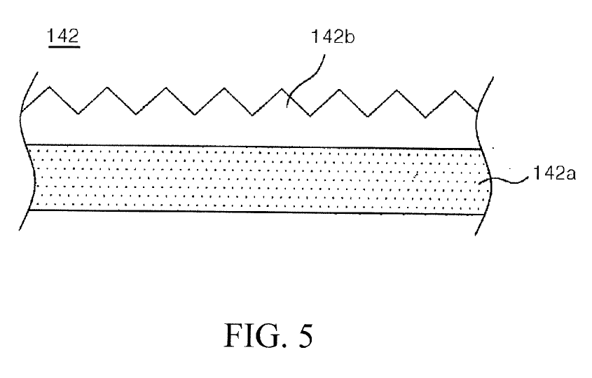

FIG. 5 is a sectional view of the forming mold depicted in FIG. 3. Although the reference number 142 is assigned to the forming mold, the concept of the embodiment can be applied to the forming mold depicted in FIG. 4.

Referring to FIG. 5, the forming mold 142 of this embodiment is provided to form the optical pattern on the base film. Therefore, the forming mold 142 may be formed of a flexible film.

That is, the forming mold 142 includes a base layer 142a and a pattern layer 142b having a fine pattern and formed on a surface of the base layer 142a. The pattern layer 142b is designed in a reverse-shaped to that of the optical pattern.

The base layer 142a of the forming mold 142 may be formed of a FET (PolyEthiylenTerephthalate) film that has a good tension strength and a good durability. The pattern layer 142b may be formed of resin, if required, mixed with a polymer material such as oligomer or hardening initiator.

The forming mold 142 of this embodiment can be applied to both the foregoing embodiments of FIGS. 3 and 4.

A method of fabricating the forming mold 142 will now be described.

A metal master formed of a thin film is fixed and polymer resin is applied on the metal master. Then, a base film material is applied on the polymer resin applied on the metal master. Then, the base film 142a for the forming mold is applied on the polymer resin applied on the master and the cylindrical roller rolls on the base film 142a to uniformly apply the pressure on the base film 142a.

At this point, the polymer resin is filled in a space formed by the pattern of the master and distributed with a uniform thickness by the pressure of the roller. Then, in a state where the polymer resin is disposed between the master and the base film, the heat or UV light is emitted to harden the base film, after which the base film is separated from the master.

Here, the base film may be formed of polymer resin or surface-processed.

As shown in FIGS. 3 and 4, when the forming molds 142 and 242 are installed on the master roll and the pattern guide roll, they must tightly contact the master roll and the guide rolls so that no bubble or foreign object exists between them.

In order to improve the work efficiency, fine holes spaced apart from each other by a predetermined distance are formed on the surfaces of the master roll and the guide roll so that the generated bubbles can be naturally removed.

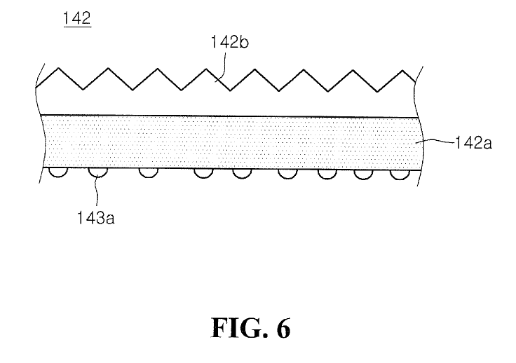

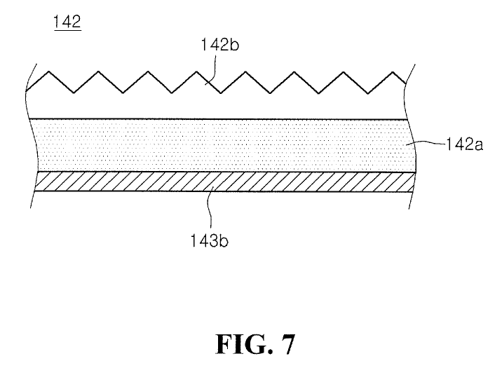

In order to reduce the pattern defective of the resultant optical member and improve the quality of the resultant optical member, the slip between the surfaces of the master roll and the pattern guide roll and the forming mold must be prevented. A forming mold according to a second embodiment of the present invention that can prevent the slip is shown in FIG. 6. FIG. 6 is a sectional view of a forming mold according to a second embodiment of the present invention and FIG. 7 is a sectional view of a forming mold according to a third embodiment of the present invention.

The forming molds illustrated in FIGS. 6 and 7 is designed not to slip on the surfaces of the master roll and the pattern guide rolls by tightly contacting the master roll and the pattern guide rolls. In FIGS. 6 and 7, although reference numeral 142 is assigned to the forming mold, the concept of these embodiments may be applied to the forming mold of FIG. 3.

Referring first to FIG. 6, a plurality of micro-scale projections 143a are formed on a bottom surface of the base layer 142a. By the projections 143a, the frictional force between the surface of the master roll or the pattern guide roll and the forming mold increases, thereby preventing the forming mold 142 from slipping on the surface of the pattern guide roll and the forming mold.

The projections 143a may be formed of rubber or silicon.

Referring to FIG. 7, a thin film 143b is formed on the bottom surface of the base layer 142a. The thin film 143b is formed of a material such as rubber or silicon having a good frictional property.

However, the present invention is not limited to the above embodiments for preventing the slip. A variety of modified examples for preventing the slip may be possible.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method of fabricating an optical member, comprising:
conveying a base film that is a base material of the optical member;
conveying a forming mold having a predetermined pattern;
allowing the base film to be engaged with the forming mold;
injecting coating liquid in an area where the base film is engaged with the forming mold;
hardening the injected coating liquid to fix the coating liquid on the base film; and
separating the forming mold from the base film on which the coating liquid is fixed.

2. The method according to claim 1, wherein the injecting the coating liquid includes filling the coating liquid in a space defined by the predetermined pattern on the forming mold.

3. The method according to claim 1, further comprising hardening the coating liquid fixed on the base film.

4. The method according to claim 3, wherein the hardening the coating liquid fixed on the base film is performed by emitting heat or ultraviolet light.

5. The method according to claim 1, wherein the forming mold is formed as a looped belt-type.
